(19) United States
(12) Patent Application Publication
(10) Pub. No.: US 2016/0270489 A1
(43) Pub. Date: Sep. 22, 2016

(54) Method for Manufacturing and Monetizing a Memorial Badge with a Permanent Mourning Band and Thin Blue Line

(71) Applicant: HERBERT EARL CULVER, JR., Miami, FL (US)

(72) Inventor: HERBERT EARL CULVER, JR., Miami, FL (US)

(21) Appl. No.: 14/660,940

(22) Filed: Mar. 18, 2015

(51) Int. Cl. A44C 3/00; G06Q 90/00

(52) U.S. Cl. CPC A44C 3/001; G06Q 90/00

(57) ABSTRACT

A method for manufacturing and monetizing a memorial badge having a permanent mourning band and thin blue line that symbolize solidarity and remembrance of a fallen government official, such as a police officer. The memorial badge includes a display surface having an insignia, mourning band, and thin blue line. The memorial badge further includes a mounting surface with a fastening mechanism that enables attachment of the mourning badge to a uniform, such that the insignia, mourning band, and thin blue line display prominently while the memorial badge is adorned. The method manufactures the mourning band by cutting and shaping the badge material; stamping the insignia, mourning band, and thin blue line into the badge; and finally coloring the insignia, mourning band, and thin blue line their respective colors. The memorial bar is sold after manufacture, with sales proceeds going to family and causes of the fallen government official.

### BACKGROUND

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

The following is an example of a specific aspect in the prior art that, while expected to be helpful to further educate the reader as to additional aspects of the prior art, is not to be construed as limiting the present invention, or any embodiments thereof, to anything stated or implied therein or inferred thereupon.

The present invention is directed to a method for manufacturing and monetizing a memorial badge having a permanent mourning band and thin blue line. The mourning band and thin blue line symbolize solidarity and remembrance of fallen officers.

The inventor has worked as a law enforcement officer for over 30 years. During this time, the inventor has witnessed the loss of numerous fallen officers in the line of duty, both through accidents and malice. The inventor knew that, from the time the officer is killed to the time the officer is buried, fellow officers traditionally adorn a mourning band across their badges. Often, a thin blue line is also extended centrally across the mourning band.

The inventor knew that both the mourning band and the thin blue line symbolize solidarity and remembrance of fallen law enforcement officers when placed on a law enforcement badge. The mourning band is worn during the time of death until the officer is laid to rest. The thin blue line signifies that the police officers stand as the thin blue line that protects society from good and evil, chaos and order.

However, the inventor noticed that during the unfortunate periods when it was necessary to adorn such a badge with a mourning band, fellow officers that didn't have a black band would simply apply black electrical tape over the badge. Often, the tape was placed on the badge sloppily. The inventor clearly saw that this ad hoc approach bordered on inadvertently disrespecting the fallen officer.

The inventor wondered if there could be a more efficient, professional way to signify brotherhood between officers. The inventor initially researched and learned that a standard metal badge could be manufactured through cutting, stamping, and polishing techniques. There were mass production factories that could produce badges, as those worn by police officers. The inventor though of how a permanent mourning band and thin blue line could be applied across the badge, such that temporary mourning bands and thin blue lines would not be necessary.

Through researching the manufacturing process, the inventor learned that the mourning band and thin blue line could be stamped on top of the insignia of the badge through standard stamping machines. The inventor also learned that a coloring agent could be poured over the mourning band and thin blue line to provide the desired black and blue colors, respectively. Enamel was glossy, relatively inexpensive, and adhered to metals efficiently.

However, the inventor was also troubled by the fact that family and favorite causes of the fallen officer received little from this type of remembrance. The inventor looked for a way to monetize the memorial badge, so that the families could benefit. So the inventor started researching marketing and sales literature.

After researching, the inventor decided to sell the badges to fellow officers to generate proceeds. The inventor then decided to donate at least 10% of the sales to the family and the favorite causes of the fallen officer. The inventor noticed that the more badges that were manufactures, the lower the manufacturing costs, and thus the more proceeds could be given to the family and causes of the fallen officer.

For the foregoing reasons, there is a method that efficiently and accurately manufactures and monetizes a memorial badge having a permanent mourning band and thin blue line. The memorial badge symbolizes solidarity shared between law enforcement officers when a fellow officer is killed in the line of duty. The memorial badge is manufactured by cutting, stamping, and coloring a badge material into a desired badge configuration.

Badge manufacturing methods have been utilized in the past; yet none with the present memorial and altruistic characteristics of the present invention. See U.S. Pat. No. 4,597,146; U.S. Pat. No. 4,901,422; and U.S. Pat. No. 6,510,629.

For the foregoing reasons, there is a method of manufacturing a black memorial badge having a permanent mourning band and thin blue line that honors fallen officers. The badge will help the family and the causes of the fallen officer when it is purchased by fellow officers.

### SUMMARY

The present invention describes a method for manufacturing a memorial badge having a permanent mourning band and thin blue line. The mourning band symbolizes solidarity and brotherhood with the police fraternity when a fellow officer is killed in the line of duty.

The memorial badge is manufactured substantially similar to a standard badge with insignia that represents law enforcement. However, the memorial badge further includes a mourning band that traverses across a central region of the memorial badge. Further, the memorial badge includes a thin blue line that traverses across a central region of the mourning band. Both the mourning band and the thin blue line are permanently integrated into the memorial badge. In this manner, a fallen officer may be remembered from the time of death to the time of burial. Furthermore, the memorial badge may be sold after manufacture, with sales proceeds going to family and causes of the fallen officer.

As described above, the mourning band and the thin blue line are permanently integrated into the memorial badge. By permanently integrating the mourning band and the thin blue line into the memorial badge, the need to deface a standard badge with an ad hoc mourning band and thin blue line is negated, i.e., black tape, markers, etc. Thus, the mourning band eliminates the problem of incorrectly incorporating the mourning band and thin blue line into a standard bar, and maintains a consistent look for all of memorial badges worn by mourning officers.

In one embodiment, the method is configured to manufacture the mourning band by cutting and shaping the badge material stamping the insignia, mourning band, and thin blue line into the memorial badge; and finally coloring the insignia, mourning band, and thin blue line their respective colors.

The memorial badge includes a display surface having an insignia, mourning band, and thin blue line. The memorial badge further includes a mounting surface with a fastening mechanism that enables attachment of the mourning badge to a uniform, such that the insignia, mourning band, and thin blue line display prominently while the memorial; badge is adorned.

The method may include an initial step of cutting a badge material into a badge that corresponds to a law enforcement agency, the badge defined by a display surface and a mounting surface. The badge is a memorial badge for remembering fallen police officers. Although, the badge may also be worn by other governmental organizational bodies such as the armed forces, the FBI, the CIA, and fire departments.

The badge may have a generally elongated shape, a round shape, a square shape, a rectangle shape, or a star shape. The badge material may include, without limitation, brass, tin, aluminum, metal alloys, wood, and a rigid polymer. A cutting machine may be used to cut the badge into the desired shape. The badge may include a perimeter edge, a display surface, and a mounting surface. A next step may include stamping an insignia onto the display surface of the badge. The insignia is a marking that corresponds to a law enforcement agency. A stamping machine may be used for this purpose.

The method may then include stamping a mourning band onto the insignia, the mourning band disposed in a generally central region of the badge, the mourning band extending fully across the badge. In this manner, the mourning band is permanently affixed across the badge in a generally horizontal disposition. However, with star-shaped badges, the mourning band extends diagonally across, and protrudes slightly from the insignia.

A following step comprises stamping a thin line onto the mourning band, the thin line disposed in a generally central region of the mourning band, the thin line extending fully across the length of the mourning band. Those skilled in the art will recognize that a thin blue line symbolizes the relationship of the law enforcement agency in the community as the protectors of the citizenry from the criminal element. Thus, a synergy is created between the mourning band and the thin line that extends centrally across the mourning band, which creates solidarity and remembrance for the fallen officer.

A next step includes spray painting the badge. The badge may be colored in this manner to correspond to the logo and duties of the law enforcement agency. Another step comprises drying the badge. The method may then include covering the mourning band with a black enamel. Traditionally, the mourning band is a black color. The enamel forms a permanent coloring agent that permanently adheres to the mourning band.

A subsequent step includes covering the thin line with a blue enamel. The blue enamel is carefully poured onto the thin line; thus forming a thin blue line. The blue enamel is prevented from mixing with the adjacent black enamel. In one embodiment, the black enamel may be dried prior to applying the blue enamel to the thin line.

Then, a next step comprises selling the badge. The badge may be sold as a memorial badge to law enforcement officials. Thus, the memorial badge might be purchased, but not used daily, until the unfortunate need to wear it arises. In one possible embodiment, the proceeds from selling the memorial badge may be used for an altruistic cause.

A final step includes donating a portion of the sales to the law enforcement agency. In keeping consistent with the memorial aspect, about 10% of sales may be donated to family and causes of the fallen officer.

One objective of the present invention is to provide a memorial badge with a permanent affixed mourning band and thin blue line.

Another objective of the present invention is to prevent ad hoc, homemade attempts to deface a standard badge with black tape while attempting to produce a black mourning band and thin blue line.

Another objective of the present invention is to generate funds for families and worthy causes of fallen officers.

Yet another objective of the present invention is to manufacture an inexpensive, easy to use memorial badge that may be adorned to remember fallen officers.

### DRAWINGS

These and other features, aspects, and advantages of the present invention will become better understood with regard to the following description, appended claims, and drawings where:

FIGS. 1A and 1B are top views of an outer surface of an exemplary badge with permanently displayed mourning band and thin blue line, where FIG. 1A is an elongated badge having the mourning band extend across horizontally, and FIG. 1B is a star-shaped badge having the mourning band extend across diagonally; and

FIGS. 2A and 2B are flowchart diagrams of an exemplary method for manufacturing a badge with a permanently displayed memorial badge and thin blue line.

### DESCRIPTION

The present invention is directed to a method 200 for manufacturing and monetizing a memorial badge 100 having a permanent mourning band 106 and thin blue line 108. The memorial badge 100 symbolizes fallen government officials. For example, a police officer killed in the line of duty by accident or malice. Those skilled in the art will recognize that it is traditional for governmental organizations to adorn their respective badges with the black mourning band 106 traversing across the badge, and the thin blue line 108 traversing across the mourning band 106. The present invention manufactures such a memorial badge 100 without requiring ad hoc or homemade attempts to apply the mourning band 106 and thin blue line 108 across a standard badge.

The memorial badge 100 is used to remember fallen government officials who are part of a governmental organization. The governmental organization may include, without limitation, a police organization, a fireman organization, a paramilitary organization, a secret service organization, medical emergency organization, and a law enforcement organization. The memorial bar is monetized by selling it to government officials, with sales proceeds going to family and causes of the fallen government official.

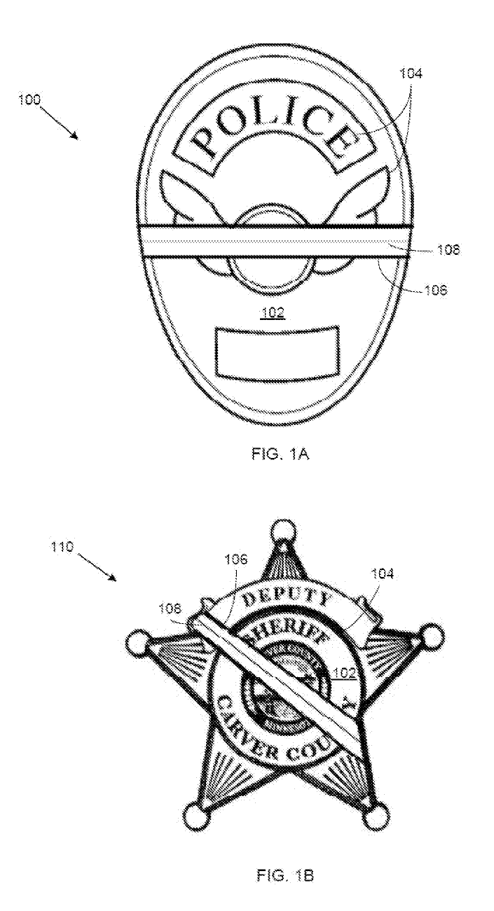

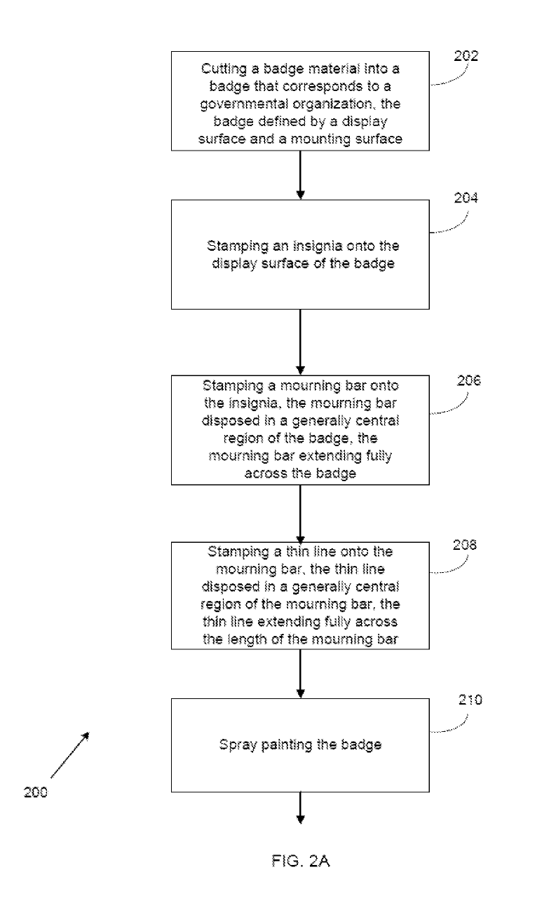

As shown in FIG. 1A, the memorial badge 100 is manufactured substantially similar to a standard badge with an insignia 104 that represents a governmental organization. The insignia may include, without limitation, text, logos, images, numerals, and decorative shapes. However, the memorial badge 100 further includes a mourning band 106 that traverses across a central region of the memorial badge 100, overlaying the insignia 104. Further, the memorial badge 100 includes a thin blue line 108 that traverses across a central region of the mourning band 106. Both the mourning band 106 and the thin blue line 108 are permanently integrated into the memorial badge 100.

As described above, the mourning band 106 and the thin blue line 108 are permanently integrated into the memorial badge 100. Those skilled in the art, in light of the present teachings, will recognize that by permanently integrating the mourning band 106 and the thin blue line 108 into the memorial badge 100, the need to deface a standard badge with an ad hoc mourning band 106 and thin blue line 108 is negated, i.e., black tape, blue markers, etc.

Thus, the mourning band 106 eliminates the problem of incorrectly incorporating the mourning band 106 and thin blue line 108 into a standard bar, and also maintains a consistent look for all of the memorial badges 100 worn by government officials. For example, attempts to deface a standard badge with black tape and markers while attempting to produce a black mourning band 106 and thin blue line 108 are prevented.

Once again looking at FIG. 1A, the memorial badge 100 may include a display surface 102 having an insignia 104, a mourning band 106, and a thin blue line 108. The display surface 102 is the side of the memorial badge 100 that is visible when adorned on a uniform. In one embodiment, the memorial badge 100 may be slightly convex, such that the display surface 102 appears to protrude from the uniform.

The memorial badge 100 further includes a mounting surface (not shown) with a fastening mechanism (not shown) that enables attachment of the mourning badge to a uniform, such that the insignia 104, mourning band 106, and thin blue line 108 display prominently while the memorial badge 100 is adorned. The fastening mechanism may include a pin that is retained into place through a latch.

FIG. 1B illustrates an exemplary star-shaped badge 110. As explained below, the star-shaped badge 110 traditionally requires the mourning band 106 to extend diagonally across the display surface 102, rather than horizontally across, as is the case for the memorial badge 100. However, the star-shaped badge 110 is substantially the same as the memorial badge 100 in every other way. For example, the thin blue line 108 still runs centrally along the length of the mourning band 106.

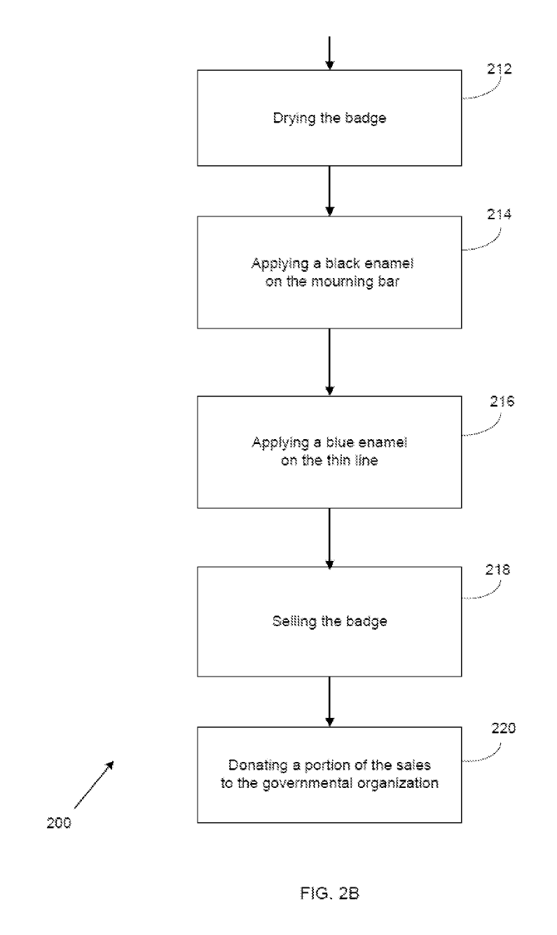

FIGS. 2A and 2B are flowchart diagrams of an exemplary method 200 for manufacturing and monetizing a memorial badge 100 with a mourning band 106 and thin blue line 108. The method 200 may include an initial Step 202 of cutting a badge material into a badge that corresponds to a governmental organization, the badge defined by a display surface 102 and a mounting surface.

The badge may have a generally elongated shape, a round shape, a square shape, a rectangle shape, or a star shape. The badge material may include, without limitation, brass, tin, aluminum, metal alloys, wood, and a rigid polymer. A cutting machine may be used to cut the badge into the desired shape. The badge may include a perimeter edge, a display surface 102, and a mounting surface. The edges and surfaces of the badge may be trimmed, polished, and washed as needed. After the Step 202 of cutting the badge, the method 200 may include steps of polishing and washing the badge to enhance the visual appeal thereof.

A next step 204 may include stamping an insignia 104 onto the display surface 102 of the badge. The insignia 104 is a marking that corresponds to the governmental organization. A stamping machine may be used for this purpose. In one possible embodiment, the stamping of the insignia 104 onto the display surface 102 of the badge may be performed by a drop hammer of a punching machine, such as a stamp/dye machine. However, other stamping means known in the art may also be used.

The method 200 may then include a Step 206 stamping a mourning band 106 onto the insignia 104, the mourning band 106 disposed in a generally central region of the badge, the mourning band 106 extending fully across the badge. Through stamping, the mourning band 106 is permanently affixed across the badge in a generally horizontal disposition. However, with star-shaped badge 110, the mourning band 106 extends diagonally across, and protrudes slightly from the insignia 104. The mourning band 106 symbolizes solidarity and brotherhood with the fallen government official.

A following Step 208 comprises stamping a thin line onto the mourning band 106, the thin line disposed in a generally central region of the mourning band 106, the thin line extending fully across the length of the mourning band 106. Those skilled in the art will recognize that a thin blue line 108 symbolizes the relationship of the governmental organization in the community as the protectors of the citizenry from the criminal element. Thus, a synergy is created between the mourning band 106 and the thin line that extends centrally across the mourning band 106, which creates solidarity and remembrance for the fallen government official.

A next Step 210 includes spray painting the badge black. Another Step 212 comprises drying the badge. The spray paint may be dried in an electrical oven before proceeding to subsequent steps. In one embodiment, the spray paint may be dried in an electrical oven at about 158° Fahrenheit.

The method 200 may then include a Step 214 of applying a black enamel on the mourning band 106. Traditionally, the mourning band 106 is a black color. The enamel forms a permanent coloring agent that permanently adheres to the mourning band 106. In one embodiment, the black enamel is poured onto the mourning band 106. In one embodiment, the enamel may be opaque or semitransparent. Those skilled in the art will recognize that enamel is efficacious for sticking to a metallic surface, such as the memorial badge 100.

A subsequent Step 216 includes applying a blue enamel on the thin line. The blue enamel is carefully poured onto the thin line; thus forming a thin blue line 108. The blue enamel is prevented from mixing with the adjacent black enamel of the mourning band 106. In one embodiment, the black enamel may be dried prior to applying the blue enamel to the thin line. In one alternative embodiment, an additional step of cleaning overflow between the black and blue enamel may be applied to the method 200.

Then, a next Step 218 comprises selling the badge. The badge may be sold as a memorial badge 100 to law enforcement officials, with a portion of sales proceeds going to family and causes of the fallen government official. In other embodiments, the memorial badge 100 may be sold to members of the public who wish to show support for the governmental organization. The “memorial” aspect is because of the memory invoked for the fallen government official with the mourning band 106 and the thin blue line 108. Thus, the memorial badge 100 might be purchased, but not used daily, until the unfortunate need to wear it arises. The memorial badge 100 may be sold through any means known in the art, including, without limitation, a brick and mortar store, online, catalog orders, and direct sales, and telemarketing sales.

A final Step 220 includes donating a portion of the sales to the governmental organization. In one possible embodiment, the proceeds from selling the memorial badge 100 may be used for an altruistic cause. In keeping consistent with the memorial aspect, about 10% of sales may be donated to family and causes of the fallen government official. However, in other embodiments, any number of government official related causes may benefit from the sales proceeds of the memorial badge 100.

While the inventor's above description contains many specificities, these should not be construed as limitations on the scope, but rather as an exemplification of several preferred embodiments thereof. Many other variations are possible. For example, the thin blue line 108 could be a thin black line, as used in England, or a thin red line for firemen. Accordingly, the scope should be determined not by the embodiments illustrated, but by the appended claims and their legal equivalents.

What is claimed is:

1. A method for manufacturing and monetizing a memorial badge having a permanent mourning band and thin blue line, the method comprising:
cutting a badge material into a badge that corresponds to a governmental organization, the badge defined by a display surface and a mounting surface;
stamping an insignia onto the display surface of the badge;
stamping a mourning band onto the insignia, the mourning band disposed in a generally central region of the badge, the mourning band extending fully across the badge;
stamping a thin line onto the mourning band, the thin line disposed in a generally central region of the mourning band, the thin line extending fully across the length of the mourning band;
spray painting the badge black;
drying the badge;
applying a black enamel on the mourning band;
applying a blue enamel on the thin line;
selling the badge; and
donating a portion of the sales to the governmental organization.

2. The method of claim 1, wherein the badge is a memorial badge for remembering dead government officials who are part of the governmental organization.

3. The method of claim 1, wherein the mourning band is about ½ an inch thick.

4. The method of claim 1, wherein the step of stamping an insignia onto the display surface of the badge is performed by a punching machine.

5. The method of claim 1, wherein the steps of stamping an insignia, mourning band, and thin line is performed by a drop hammer in a stamp/dye machine.

6. The method of claim 1, further including the step of polishing the badge.

7. The method of claim 1, further including the step of washing the badge.

8. The method of claim 1, wherein the step of drying the badge occurs in an electrical oven at about 158 degrees Fahrenheit.

9. The method of claim 1, further including the step of cleaning overflow of black enamel and blue enamel.

10. The method of claim 1, further including the step of inspecting the badge.

11. The method of claim 1, wherein the step of donating a portion of the sales to the governmental organization includes donating about 10 percent.

12. The method of claim 1, wherein the governmental organization includes at least one member selected from the group consisting of: a police organization, a fireman organization, a paramilitary organization, a secret service organization, medical emergency organization, and a law enforcement organization.

13. The method of claim 1, wherein the badge is generally elongated.

14. The method of claim 1, wherein the badge material includes at least one member selected from the group consisting of: brass, tin, aluminum, metal alloys, wood, and a rigid polymer.

15. The method of claim 1, wherein the mourning band and the thin line protrude from the insignia.

16. The method of claim 1, wherein the thin line is colored with a red enamel.

17. A method for manufacturing and monetizing a memorial badge having a permanent mourning band and thin blue line, the method comprising:
cutting a badge material into a badge that corresponds to a governmental organization, the badge defined by a display surface and a mounting surface;
polishing the badge;
washing the badge;
stamping an insignia onto the display surface of the badge;
stamping a mourning band onto the insignia, the mourning band disposed in a generally central region of the badge, the mourning band extending fully across the badge;
stamping a thin line onto the mourning band, the thin line disposed in a generally central region of the mourning band, the thin line extending fully across the length of the mourning band;
spray painting the badge black;
drying the badge;
applying a black enamel on the mourning band;
applying a blue enamel on the thin line;
cleaning overflow of black enamel and blue enamel;
inspecting the badge;
selling the badge; and
donating about 10 percent of the sales to the governmental organization.

18. The method of claim 17, wherein the mourning band is about ½ an inch thick.

19. The method of claim 17, wherein the governmental organization is a police organization.

20. A method for manufacturing and monetizing a star-shaped memorial badge having a permanent mourning band and thin blue line, the method comprising:
cutting a badge material into a star-shaped badge that corresponds to a governmental organization, the star-shaped badge defined by a display surface and a mounting surface;
stamping an insignia onto the display surface of the star-shaped badge;
stamping a mourning band onto the insignia, the mourning band disposed diagonally across the star-shaped badge;
stamping a thin line onto the mourning band, the thin line disposed in a generally central region of the mourning band, the thin line extending fully across the length of the mourning band;
spray painting the star-shaped badge black;
drying the star-shaped badge;
applying a black enamel on the mourning band;
applying a blue enamel on the thin line;
selling the star-shaped badge; and
donating a portion of the sales to the governmental organization.
